(19) United States
(12) Patent Application Publication
(10) Pub. No.: US 2026/0230134 A1
(43) Pub. Date: Aug. 6, 2026

(54) METHOD AND APPARATUS FOR WIRELESS COMMUNICATION

(71) Applicant: QUECTEL WIRELESS SOLUTIONS CO., LTD., Shanghai (CN)

(72) Inventors: Ling LYU, Frisco, TX (US); Zheng ZHAO, Shanghai (CN)

(21) Appl. No.: 19/578,801

(22) Filed: Mar. 25, 2026

Related U.S. Application Data
(63) Continuation of application No. PCT/CN2024/126097, filed on Oct. 21, 2024.

(51) Int. Cl. H04B 7/06

(52) U.S. Cl. CPC H04B 7/0617; H04B 7/0626

(57) ABSTRACT

Provided are a wireless communication method and apparatus. One example method includes: receiving first configuration information, wherein the first configuration information indicates an association identity (ID); and performing, based on the association ID, model training and model inference on a first model, wherein the first model corresponds to a first beam set and a second beam set, and the association ID comprises one or more of following: a set ID used for selecting at least one of the first beam set or the second beam set; or a beam ID group, comprising an ID of each beam in at least one of the first beam set or the second beam set.

### CROSS-REFERENCE TO RELATED APPLICATIONS

This application is a continuation of International Application No. PCT/CN2024/126097, filed on October 21, 2024, the disclosure of which is hereby incorporated by reference in its entirety.

### TECHNICAL FIELD

The present application relates to the field of communications technologies, and more specifically, to a method and an apparatus for wireless communication.

### BACKGROUND

In some beam management scenarios, a terminal device may predict a downlink transmit beam by using a model and report the predicted downlink transmit beam to a network device. The model is required to be trained before being used for inference and prediction. However, there may be a time interval between a training phase and an inference phase. If a transmission condition of a beam changes, the model may cause an error during the inference phase. Therefore, how to ensure consistency of the model between the training phase and the inference phase is an urgent technical problem to be resolved.

### SUMMARY

The present application provides a method and an apparatus for wireless communication. Various aspects of embodiments of the present application are described below.

According to a first aspect, a wireless communication method is provided, and the method includes: receiving, by a terminal device, first configuration information, where the first configuration information is used to indicate an association identity (identity ID); and performing, by the terminal device based on the association ID, model training and model inference on a first model, where the first model corresponds to a first beam set and a second beam set, and the association ID includes one or more of the following: a set ID used for selecting the first beam set and/or the second beam set; or a beam ID group, including an ID of each beam in the first beam set and/or the second beam set.

According to a second aspect, a wireless communication method is provided, and the method includes: transmitting, by a network device, first configuration information, where the first configuration information is used to indicate an association ID, where the association ID is used by a terminal device to perform model training and model inference on a first model, the first model corresponds to a first beam set and a second beam set, and the association ID includes one or more of the following: a set ID used for selecting the first beam set and/or the second beam set; or a beam ID group, including an ID of each beam in the first beam set and/or the second beam set.

According to a third aspect, an apparatus for wireless communication is provided, where the apparatus is a terminal device, and includes: a transceiver unit, receiving first configuration information, where the first configuration information is used to indicate an association ID; and a determining unit, performing model training and model inference on a first model based on the association ID. The first model corresponds to a first beam set and a second beam set, and the association ID includes one or more of the following: a set ID used for selecting the first beam set and/or the second beam set; or a beam ID group, including an ID of each beam in the first beam set and/or the second beam set.

According to a fourth aspect, an apparatus for wireless communication is provided, where the apparatus is a network device, and includes: a transceiver unit, transmitting first configuration information, where the first configuration information is used to indicate an association ID. The association ID is used by a terminal device to perform model training and model inference on a first model, the first model corresponds to a first beam set and a second beam set, and the association ID includes one or more of the following: a set ID used for selecting the first beam set and/or the second beam set; or a beam ID group, including an ID of each beam in the first beam set and/or the second beam set.

According to a fifth aspect, a communications apparatus is provided, including a memory and a processor, where the memory is configured to store a program, and the processor is configured to invoke the program in the memory to perform the method according to the first aspect or the second aspect.

According to a sixth aspect, an apparatus is provided, and the apparatus includes a processor configured to invoke a program from a memory to execute the method according to the first aspect or the second aspect.

According to a seventh aspect, a chip is provided, and the chip includes a processor configured to invoke a program from a memory, to cause a device on which the chip is installed to execute the method according to the first aspect or the second aspect.

According to an eighth aspect, a computer-readable storage medium is provided, where the computer-readable storage medium stores a program, and the program causes a computer to execute the method according to the first aspect or the second aspect.

According to a ninth aspect, a computer program product is provided, and the computer program product includes a program that causes a computer to execute the method according to the first aspect or the second aspect.

According to a tenth aspect, a computer program is provided, where the computer program causes a computer to execute the method according to the first aspect or the second aspect.

In embodiments of the present application, a terminal device may determine an association ID based on first configuration information, so as to perform model training and model inference on a first model based on the association ID. In other words, the terminal device performs beam measurement and beam prediction based on a same ID. When a beam transmission condition changes, the association ID may change, and the terminal device may update the first model in a timely manner, thereby improving prediction accuracy.

### BRIEF DESCRIPTION OF THE DRAWINGS

FIG. 1 shows a wireless communications system to which embodiments of the present application are applied.

FIG. 2 is a schematic diagram of a model processing process to which embodiments of the present application are applied.

FIG. 3 is a schematic flowchart of model inference on a terminal device side to which embodiments of the present application are applied.

FIG. 4 is a schematic flowchart of a method for wireless communication according to an embodiment of the present application.

FIG. 5 is a schematic diagram of a possible implementation of the method shown in FIG. 4.

FIG. 6 is a schematic diagram of another possible implementation of the method shown in FIG. 4.

FIG. 7 is a schematic diagram of still another possible implementation of the method shown in FIG. 4.

FIG. 8 is a schematic diagram of still another possible implementation of the method shown in FIG. 4.

FIG. 9 is a schematic diagram of still another possible implementation of the method shown in FIG. 4.

FIG. 10 is a schematic flowchart of a possible implementation of the method shown in FIG. 4.

FIG. 11 is a schematic structural diagram of an apparatus for wireless communication according to an embodiment of the present application.

FIG. 12 is a schematic structural diagram of another apparatus for wireless communication according to an embodiment of the present application.

FIG. 13 is a schematic structural diagram of a wireless communications apparatus according to an embodiment of the present application.

### DETAILED DESCRIPTION OF THE EMBODIMENTS

The following describes the technical solutions in embodiments of the present application with reference to the accompanying drawings.

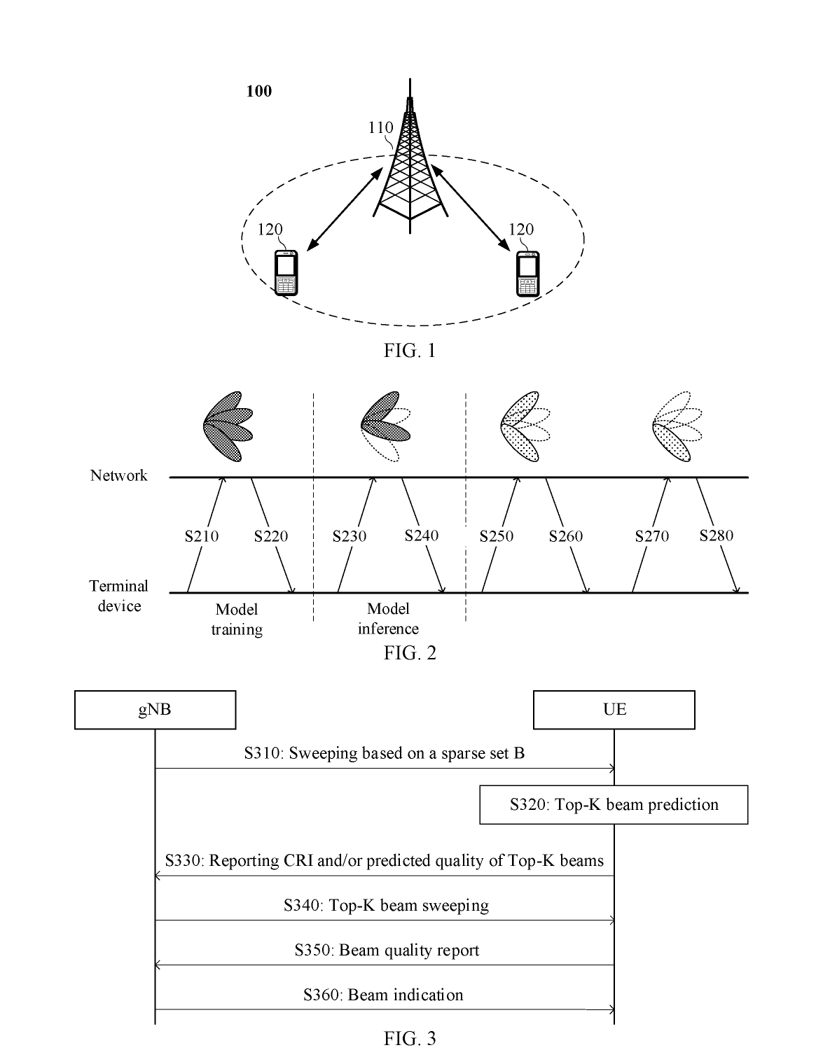

FIG. 1 is a schematic diagram of an architecture of a wireless communications system 100 to which embodiments of the present application are applied. As shown in FIG. 1, the wireless communications system 100 may include a network device 110 and a terminal device 120. The network device 110 may be a device that communicates with the terminal device 120. The network device 110 may provide communication coverage for a specific geographic area, and may communicate with a terminal device located within the coverage.

FIG. 1 exemplarily shows one network device and two terminal devices. Optionally, the wireless communications system 100 may include a plurality of network devices, and coverage of each network device may include another quantity of terminal devices. This is not limited herein. In other words, the wireless communications system may include one or more network devices, and each network device may support wireless communication of one or more terminal devices.

In embodiments of the present application, the wireless communications system shown in FIG. 1 may further include other network entities such as a mobility management entity (mobility management entity, MME), or an access and mobility management function (access and mobility management function, AMF), and a network controller, which is not limited in embodiments of the present application.

It should be understood that embodiments of the present application may be applied to various communications systems. For example, embodiments of the present application may be applied to a global system for mobile communications (global system of mobile communication, GSM), a code division multiple access (code division multiple access, CDMA) system, a wideband code division multiple access (wideband code division multiple access, WCDMA) system, a general packet radio service (general packet radio service, GPRS) system, a long term evolution (long term evolution, LTE) system, an advanced long term evolution (advanced long term evolution, LTE-A) system, a new radio (new radio, NR) system, an evolved system of an NR system, an LTE-based access to unlicensed spectrum (LTE-based access to unlicensed spectrum, LTE-U) system, an NR-based access to unlicensed spectrum (NR-based access to unlicensed spectrum, NR-U) system, a universal mobile telecommunications system (universal mobile telecommunication system, UMTS), a wireless local area network (wireless local area networks, WLAN) system, a wireless fidelity (wireless fidelity, WiFi) system, and a 5th-generation (5th-generation, 5G) communications system. Embodiments of the present application may be further applied to another communications system, for example, a future communications system such as a 6th-generation (6th-generation, 6G) mobile communications system or a satellite (satellite) communications system.

Conventional communications systems support a limited quantity of connections and are easy to implement. However, with development of communications technologies, a communications system may support not only conventional cellular communications but also one or more other types of communications. For example, the communications system may support one or more types of the following communication: device-to-device (device to device, D2D) communication, machine-to-machine (machine to machine, M2M) communication, machine type communication (machine type communication, MTC), enhanced machine type communication (enhanced MTC, eMTC), vehicle-to-vehicle (vehicle to vehicle, V2V) communication, vehicle-to-everything (vehicle to everything, V2X) communication, and the like. Embodiments of the present application may also be applied to a communications system that supports the foregoing communication manners.

The communications system in embodiments of the present application may be applied to a carrier aggregation (carrier aggregation, CA) scenario, a dual connectivity (dual connectivity, DC) scenario, or a standalone (standalone, SA) networking scenario.

The communications system in embodiments of the present application may be applied to an unlicensed spectrum. The unlicensed spectrum may also be considered as a shared spectrum. Alternatively, the communications system in embodiments of the present application may be applied to a licensed spectrum. The licensed spectrum may also be considered as a dedicated spectrum.

Embodiments of the present application may be applied to a non-terrestrial network (non-terrestrial network, NTN) system. For example, the NTN system may be a 4G-based NTN system, an NR-based NTN system, an NTN system based on an internet of things (internet of things, IoT), or an NTN system based on a narrow band internet of things (narrow band internet of things, NB-IoT).

The wireless communications system in embodiments of the present application may use the following resources to support wireless communication with one or more communications devices: time resources (for example, symbols, subslots, slots, subframes, and frames) or frequency resources (for example, subcarriers and carriers). Additionally, the wireless communications system may support wireless communication across various radio access technologies (radio access technology, RAT). The various radio access technologies include 3rd generation (3G) radio access technologies, 4th generation (4G) radio access technologies, 5th generation (5G) radio access technologies, and other suitable radio access technologies beyond 5G.

The terminal device in embodiments of the present application may also be referred to as a user equipment (user equipment, UE), an access terminal, a subscriber unit, a subscriber station, a mobile site, a mobile station (mobile station, MS), a mobile terminal (mobile Terminal, MT), a remote station, a remote terminal, a mobile device, a user terminal, a terminal, a user communications device, a wireless communications device, a user agent, a user apparatus, or the like.

In some embodiments, the terminal device in embodiments of the present application may be a device providing a user with voice and/or data connectivity and capable of connecting people, objects, and machines, such as a handheld device or a vehicle-mounted device having a wireless connection function. The terminal device in embodiments of the present application may be a mobile phone (mobile phone), a tablet computer (pad), a notebook computer, a palmtop computer, a mobile Internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like. Optionally, a UE may be configured to function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart home device communicate with each other, without relaying a communication signal through a base station.

In some embodiments, the terminal device may be a station (STATION, ST) in a WLAN. In some embodiments, the terminal device may be a cellular phone, a cordless phone, a session initiation protocol (session initiation protocol, SIP) phone, a wireless local loop (wireless local loop, WLL) station, a personal digital assistant (personal digital assistant, PDA) device, a handheld device with a wireless communication function, a computing device, or another processing device connected to a wireless modem, a vehicle-mounted device, a wearable device, a terminal device in a next-generation communications system (such as an NR system), a terminal device in a future evolved public land mobile network (public land mobile network, PLMN), or the like.

The network device in embodiments of the present application may be a device for communicating with the terminal device. The network device may also be referred to as an access network device or a wireless access network device. The network device may be, for example, a base station. The network device in embodiments of the present application may be a radio access network (radio access network, RAN) node (or device) that connects the terminal device to a wireless network. The base station may broadly cover various names in the following, or may be interchanged with the following names, for example, a NodeB (NodeB), an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master eNodeB (MeNB), a secondary eNodeB (SeNB), a multi-standard radio (MSR) node, a home base station, a network controller, an access node, a wireless node, an access point (access point, AP), a transmission node, a transceiver node, a base band unit (base band unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), a positioning node, a network communications device, or the like. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in D2D, V2X, or M2M communications, a network-side device in a 6G network, a device that functions as a base station in a future communications system, or the like. The base station may support networks of a same access technology or different access technologies. A specific technology and a specific device form used by the network device are not limited in embodiments of the present application.

The base station may be a fixed or mobile base station. For example, a helicopter or an unmanned aerial vehicle may be configured to act as a mobile base station, and one or more cells may move based on a position of the mobile base station. In another example, a helicopter or an unmanned aerial vehicle may be configured to serve as a device in communication with another base station.

In some deployments, the network device in embodiments of the present application may be a CU or a DU, or the network device may include a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. A scenario in which the network device and the terminal device are located is not limited in embodiments of the present application.

It should be understood that all or some of functions of the communications device in the present application may alternatively be implemented by software functions running on hardware, or by virtualization functions instantiated on a platform (for example, a cloud platform).

In embodiments of the present application, the network device may provide a service for a cell, and the terminal device communicates with the network device by using a transmission resource (for example, a frequency resource or a spectrum resource) used by the cell. The cell may be a cell corresponding to the network device (for example, a base station). The cell may belong to a macro base station or belong to a base station corresponding to a small cell. The small cell herein may include: a metro cell (metro cell), a micro cell (micro cell), a pico cell (pico cell), a femto cell (femto cell), or the like. These small cells feature small coverage and low transmit power, and are suitable for providing a high-speed data transmission service.

It should be understood that a device having a communication function in a network/system in embodiments of the present application may be referred to as a communications device. The wireless communications system 100 shown in FIG. 1 is used as an example. The communications device may include a network device 110 and a terminal device 120 that have a communication function, and may further include another device in the wireless communications system 100, for example, another network entity such as a network controller or a mobility management entity, which is not limited in embodiments of the present application.

For ease of understanding, some relevant technical knowledge related to embodiments of the present application is first described. The following related technologies, as optional solutions, may be randomly combined with the technical solutions of embodiments of the present application, all of which fall within the protection scope of embodiments of the present application. Embodiments of the present application include at least a part of the following content.

In a wireless communications system, a terminal device may obtain a beam (which may also be referred to as a spatial beam), to implement a wireless connection from the terminal device to a wireless network. For example, the terminal device may perform beam sweeping on an available beam transmitted by the wireless network, and measure attributes of the beam. The attributes of the beam are, for example, signal strength and signal quality. For example, after performing beam sweeping, the terminal device may further perform beam refinement, to achieve a group of potentially narrower beams used for wireless connection to the wireless network. The beam may not only be used to implement wireless connection between the terminal device and the wireless network, but also implement high directional precision and high signal quality for wireless signal transmission between the terminal device and the wireless network.

With development of communication technologies, research on artificial intelligence (artificial intelligence, AI)/machine learning (machine learning, ML) technologies based on air interfaces of communications systems (for example, NR systems) becomes one of directions. An objective of the research includes exploring how to enhance an advantage of the air interface. For example, related performance of the air interface can be enhanced by enhancing support for AI/ML algorithms. For another example, complexity and/or overheads of the air interface can be reduced by enhancing support for AI/ML algorithms.

Research on AI/ML technologies can also enhance capabilities related to beam management (beam management, BM). In an example, AI/ML enhancements related to beam management may help reduce overheads and lower beam measurement and reporting delay. In an example, an AI/ML model may be applied to predict a beam, so as to improve transmission efficiency of the air interface.

A whole process of applying an AI/ML model for enhancement includes: model training, model inference, and model monitoring. In this process, the AI/ML model, after being trained, can generate a set of outputs based on a set of inputs. The input may be a set of beam measurements, and the output may be a set of beams different from or larger than the input.

In a model inference process, the AI/ML model may predict a best beam in a set of different or larger set of beams by using a set of beam measurements.

In some embodiments, the AI/ML model may be located on the side of the terminal device or the terminal device performs model training and/or model inference. The model may be referred to as a UE-side model (UE-side model). For example, the AI model may be located at the terminal device or the terminal device trains the AI model and/or generates a best beam by using inference of the AI model.

In an example, the terminal device may use a beam in a set B (Set B, also referred to as beam group B) as an input of the ML model. The ML model may predict a best beam in a set A (Set A, also referred to as beam group A), and the beam is not completely measured by the terminal device.

In the example described above, the set B may be a beam group first measured by the terminal device. The set B may be a plurality of beams transmitted by a base station (for example, a gNB). Different beams may correspond to different directions or angles, so as to cover a plurality of spatial directions. Each beam may further correspond to a measurement signal used for obtaining a measurement, such as a reference signal received power (reference signal received power, RSRP). The set B is used to provide the model with preliminary environmental information and channel conditions.

In the example described above, the set A may be a beam group that needs to be predicted. The set A usually has a larger quantity of beams than set B, or may have more concentrated beam directions. The AI/ML model may predict a best beam in the set A by measuring the set B, to improve data transmission efficiency.

Optionally, beams in the set A and the set B may be in a same frequency range. Selection of the set B may be defined by the base station or determined by the terminal device itself. A relationship between the set A and the set B may be that: the set A is different from the set B (the set B is not a subset of the set A), the set B is a subset of the set A (the set A is different from the set B), or the set A is the same as the set B. For the first two relationships, the set B may be transmitted simultaneously in a measurement window and a prediction window, or may be transmitted only in the measurement window. For the last case, reference signal (reference signal, RS) transmission overheads may be reduced, and the set B used as a measurement resource may be transmitted only in the measurement window.

Optionally, 64 or more beams may be used as a size of the beam set A. For future-oriented networks, a network device will be able to transmit 64 more highly directional narrow beams. More narrow beams may also be used to sweep a larger set A. For example, a quantity of beams in the set A may be as large as 256.

Optionally, the network device may transmit a channel state information reference signal (channel state information-reference signal, CSI-RS) or a synchronization signal block (synchronization signal block, SSB) as a reference signal. It should be understood that the SSB may also represent a synchronization signal/physical broadcast channel block (synchronization signal/physical broadcast channel block, SS/PBCH block). The SSB includes a primary synchronization signal (primary synchronization signal, PSS) and a secondary synchronization signal (secondary synchronization signal, SSS).

Optionally, the terminal device estimates channel quality of a respective beam by measuring an RSRP of the received CSI-RS/SSS.

Optionally, in a model training process, the AI/ML model may adjust its weight by minimizing a loss function, so that the model can accurately predict a best beam in the set A from an RSRP measurement result of the set B.

In some embodiments, the AI/ML may be located on a network device (such as a base station) side, or the network device performs model training and/or model inference. The model may be referred to as a network-side model (NW-side model). For example, the AI model may be located at the base station or the base station trains the AI model and/or generates a best beam by using inference of the AI model.

In some embodiments, a network may completely control a data collection process of model training on the terminal device side, including starting, termination, and management of data collection and data transmission.

During a model monitoring process, AI/ML model monitoring is used for at least the following purposes: model activation, deactivation, selection, switching, backoff, and updating (including retraining). The model monitoring may also be referred to as a process of monitoring AI/ML model inference performance. There is definitely a time interval between model training and inference. When a radio parameter/condition changes in the network, errors occur in an inference phase of a model with a high probability, and therefore the model needs to be continuously modified and trained based on a result of the model monitoring.

In comparison with other beam management technologies, based on beam prediction, the terminal device can experience a reduced delay, reduced overheads, reduced power consumption, and improved signal quality by using beam management that supports the AI/ML technology.

For ease of understanding, the following describes an entire process of model processing on the terminal device side with reference to FIG. 2. FIG. 2 is shown from a perspective of interaction between a terminal device side (for example, a UE) and a network (a network, NW) side. Four beams on the network side are used as an example. It can be learned from FIG. 2 that the entire process may include a model training (model training) process, a model inference (model inference) process, and a reporting process. The model training process includes Step S210 and Step S220, and the model inference process includes Step S230 and Step S240.

Referring to FIG. 2, in Step S210, a terminal device reports training-related information (UE report training-related information).

In Step S220, the network side performs beam sweeping (beam scanning) based on the four beams.

In Step S230, the terminal device reports inference-related information (UE report inference-related information).

In Step S240, the network side selects two beams from the four beams based on the reporting from the terminal device to perform beam sweeping.

In Step S250, the terminal device reports top-K beams (report top-K beams).

In Step S260, the network side performs beam sweeping based on beams in the beam report. It may be learned from FIG. 2 that the two beams on which the network side performs beam sweeping in Step S260 may be different from the two beams on which the network side performs beam sweeping in Step S240.

In Step S270, the terminal device transmits a beam report (beam report), so that the network side determines an optimal beam.

In Step S280, the network side transmits a beam indication (beam indication) to the terminal device.

The foregoing describes, with reference to FIG. 2, a process of processing a model when the model is located on the terminal device side. To complete the entire process, the terminal device needs to collect and analyze data. As previously described, a data collection process may include starting, transmission, and management of data collection and data transmission. The following describes data collection and analysis by using a model on a terminal device side as an example.

For the model on the terminal device side, a behavior of the terminal device or content that the terminal device reports may vary depending on whether it is a measurement resource for training, inference, or monitoring. In other words, the content may be different for different terminal device behaviors or terminal device reports. Therefore, during configuration of measurement related to an AI/ML operation for the model on the terminal device side, a purpose of the measurement configuration or an implied terminal device behavior (for example, training, inference, monitoring, or a non-AI/ML operation) needs to be indicated to the terminal device.

In an example, for the training process, the terminal device may only need to measure a beam for which a resource is configured. For example, model inputs and labels generated based on a set A/set B may be used for internal training on the terminal device side, and may not need to be reported to the network device.

In an example, for the inference process, the terminal device may need to measure a transmit (transmit, Tx) beam from the set B and use it as a model input, and in addition, the terminal device should report a model output about a predicted beam/RSRP value.

For data collection, in embodiments of the present application, data collection may be started/triggered by a configuration of a network, or data collection may be performed in response to a request from the terminal device. Data collection for different purposes may correspond to different behaviors of the terminal device.

In an example, collected data may be used to train an AI model or allow the terminal device to have a preliminary understanding of network performance. When performing data collection based on a training data set, the terminal device needs to be equipped with a mechanism to determine when to collect data and what data is to be collected for effective training. Because the network side may not know a specific data requirement of the terminal device or an optimal time for data collection, the terminal device may autonomously trigger the collection process and report a related configuration. For example, for an AI/ML model on the terminal device side, an input of the AI/ML model may include layer 1 (layer 1, L1) RSRPs of8 SSBs, and an output may include predicted L1-RSRPs of 32 CSI-RSs. The 8 SSBs may correspond to the set B used for training purposes, and the 32 CSI RSs may correspond to the set A used for training purposes.

The AI/ML model in the foregoing example is used as an example. In order that the terminal device collects data used for training the AI/ML model, the network may configure a first SSB resource set and a first CSI-RS resource set for the terminal device. In the first SSB resource set, an SSB resource indicator (resource indicator, RI) or resource index (resource index, RI) may range from 1 to 8. The SSB RI may be defined based on IDs associated with respective SSBs in the SSB resource set. In the first CSI-RS resource set, a CSI-RS resource indicator or index (CSI-RS RI, CRI) may range from 1 to 32. The CRI may be defined based on IDs associated with respective CSI-RSs in a CSI-RS resource set.

Optionally, a CSI-RS in the first CSI-RS resource set shares a same periodicity as an SSB in the first SSB resource set.

Optionally, the terminal device may collect L1-RSRPs about an SSB and a CSI-RS in various time scenarios, and upload data to an over the top (over the top, OTT) server for offline model training.

Optionally, in the model training process, an L1-RSRP corresponding to an SSB RI=m (1 ≤ m ≤ 8) in the first SSB resource set may be used to determine an input value of the m^{th} input feature of the AI/ML model, and an L1-RSRP corresponding to a CRI=n (1 ≤ n ≤ 32) in the first CSI-RS resource set may be used to determine a value label related to the n^{th} output feature of the AI/ML model. Then, this offline-trained AI/ML model may be downloaded back to the terminal device for future model inference.

In an example, for the model on a terminal device side, the training data may be generated by the terminal device. The endpoint of the training data may include a terminal device or an OTT server on a terminal device side. Operation administration and maintenance (operation administration and maintenance, OAM) or a core network may be used to collect information about training of the model on the terminal device side.

In the foregoing example, the OTT server on the terminal device side collects data and trains the model. Therefore, the OTT server on the terminal device side knows what data it needs. Data collection on the terminal device side being implemented by the OTT server means that the OTT server may directly collect required data. A required data type does not need to be specified, and when/what to transmit is determined by the terminal device, which may provide sufficient flexibility for a terminal device/chipset vendor to train and implement its specific AI/ML model. The terminal device may transmit training data to the OTT server on the terminal device side by using a same method for model training. Such a process is transparent to the network side and does not require control/visibility from a network/mobile network operator (mobile network operator, MNO).

In the foregoing example, the terminal device itself shall be responsible for protecting data privacy and obtaining user consent. More specifically, the training data is reported via a user plane (user plane, UP), that is, from an application-level data collection client of the terminal device to an application server (that is, the OTT server on the terminal device side). The terminal device vendor may install a data collection client on the terminal device to collect lower-layer data and report the data to its application server for AI/ML model training. For the data collection application client on the terminal device, data transmission from the terminal device to the application server of the terminal device vendor may be supported in accordance with relevant regulations without participation of the network side. A type/format of collected data does not need to be specified, which provides sufficient flexibility for the terminal device to train and implement its specific AI/ML model.

In an example, after collecting the training data, the terminal device may first transmit the training data to a data collection server (within the MNO) for training of the model on the terminal device side. Then, the training data may be transmitted from the data collection server to an OTT server (outside the MNO). In other words, the terminal device may collect data and transmit the data to a server for data collection for training of the model on the terminal device side. The data collection server for training of the model on the terminal device side may be marked as a first entity.

In the foregoing example, the first entity may choose whether to transmit the collected data to an OTT server. This OTT server has a different ownership from the OTT server in the previous example. The terminal device may transmit the collected data to the first entity within the MNO through the UP, and then the first entity may choose to forward the collected data to the OTT server. This process depends on implementation by the terminal device.

The model on the terminal device side is still used as an example below to describe a model inference and reporting process. The process also includes a beam management inference process.

For an inference process of the model on the terminal device side, the terminal device measures RSs of beams in the set B, predicts Top-K beams in the set A, and reports a prediction result to the network. In a conventional L1-RSRP report, the terminal device should report an L1-RSRP value of a channel measurement resource (channel measurement resource, CMR) related to the CSI report. However, for artificial intelligence-based beam management, a beam group (set B) used for measurement may be different from a beam group (set A) used for reporting. Therefore, to instruct the terminal device to report a prediction result, an association between the set A and the set B should be indicated to the terminal device.

It should be noted that, the association between the set A and the set B also needs to be confirmed in the model training process. For model training, a measurement result of the set B is used as a model input and a measurement result of the set A is used as a truth label. Therefore, the set B may be associated with the set A by: configuring both a resource of the set A and a resource of the set B for the terminal device in advance. However, for model inference, the terminal device only needs to measure beams in the set B, and resources or indexes of beams in the set A are used only for reporting. Therefore, a key issue in the model inference process is how to represent resources or indexes of the set A.

In the inference process, the terminal device does not measure the beams in the set A. Therefore, RSs of the beams in the set A do not need to be configured. However, in some scenarios, the RSs of the beams in the set A may be configured for the terminal device for other purposes, for example, for performance monitoring. In this case, both a resource set of the set B and a resource set of the set A are configured for the terminal device. It may be learned that the network may configure the resource set of the set B and the resource set of the set A depending on different purposes. A CSI resource is used as an example. The terminal device needs to know an intention of the configured CSI resource (for training, inference, monitoring, or a non-AI/ML operation), because a corresponding CSI report type may vary.

In an example, for a monitoring process, based on a result of discussion of a monitoring type, the terminal device may need to measure a monitoring resource configured by the network device and report a model output/label, or report a calculated metric (for example, beam prediction accuracy). For a conventional non-AI/ML operation, the terminal device may need to measure Tx beams and report the measured beams/RSRPs.

In an inference process of the AI/ML model, a measurement based on the beams in the set B may be used as a model input. In addition, beam ID information may be further provided as the model input. Based on the model output, the Top-1/Top-K beam in the set A may be obtained (obtain Top-1/K beams among Set A of beams), or the Top-1/Top-K beam in the set A may be determined using the predicted L1-RSRP (depending on the label).

Optionally, the model output is, for example, a probability of each beam in the set A to be the Top-1 beam (probability of each beam in Set A to be the Top-1 beam), or a predicted L1-RSRP (predicted LI-RSRPs).

In some scenarios, the terminal device may support beam prediction in spatial domain and/or time domain, that is, BM-Case1 and/or BM-Case2. Based on AI/ML enhancements, the beam prediction in spatial domain (BM-Case1) and the beam prediction in time domain (BM-Case2) can reduce overheads of the terminal device and decrease delays in beam measurement and reporting.

BM-Case1 is spatial domain downlink (downlink, DL) beam prediction for the set A based on a measurement result of the set B. For BM-case1, measurements of the set B (measurements based on Set B of beams) are used as a model input to predict the Top-1/Top-K beams in the set A.

BM-Case2 is time domain DL beam prediction for the set A based on a historical measurement result of the set B. For BM-Case2, measurements of the beams in the set B at one or more historical time instances (measurements based on Set B of beams at historic time instance(s)) may be used as a model input, to predict time domain DL beams of the beams in the set A. Prediction of DL Tx beams and prediction of DL Tx/Rx beams may further be used to evaluate prediction performance.

For BM-Case1 and BM-Case2, the terminal device may report a prediction result to the NW based on outputs of the model on the terminal device side, or the NW may predict Top-1/Top-K beams based on a measurement report of the set B of the NW-side model.

The model on the terminal device side is still used as an example. For BM-Case1 having an AI/ML model on the terminal device side, a conventional transmission configuration indicator (transmission configuration indicator, TCI) state mechanism may be used for beam indication of a beam. Optionally, the terminal device may report a measurement result of four or more beams in one reporting instance. For BM-Case2 with the AI/ML model located on the terminal device side, the terminal device may report the following information related to AI/ML model inference to the NW in a report example: beams to be used in N future times output based on the AI/ML model inference; timestamp information corresponding to the reported beams; and information about measurements from a plurality of past time instances.

In a beam management inference process, the beam indication is also important information. After the terminal device reports the Top-K predicted beams, the NW further indicates beams used for second-step measurement, or the terminal device may directly trigger the second-step measurement. Different from BM-case1, in BM-Case2, Top-K beams corresponding to a plurality of time instances may be obtained. Time information needs to be considered for beam indication on the network device side.

In an example, the network device may indicate beams to the terminal device by using a plurality of indications. An advantage of this operation is that the network device may select a more appropriate beam based on a real-time channel change.

With reference to FIG. 3, the following describes a beam prediction-based model inference process based on interaction between a UE and a gNB by using a UE-side model as an example.

Referring to FIG. 3, in Step S310, the gNB performs sweeping based on a sparse set B (sparse Set B sweeping).

In Step S320, the UE-side model performs Top-K beam prediction (Top-K beam prediction). The UE inputs measurements of beams in the set B into an AI model, and outputs indexes, L1-RSRPs, and beam IDs or beam indexes of top K beams in all measured beams. The UE-side model may further output an LI-RSRP of a best beam and differences between RSRPs of other K–1 beams and the L1-RSRP of the best beam, and report the differences to a base station. A value of K may be configured by the base station, or the UE may determine the value of K based on a moving speed, location information, and a service mode.

In Step S330, at least one of CRI or predicted quality of Top-K beams is reported (report CRI and/or predicted quality of Top K beam).

In Step S340, the gNB may continue to initiate sweeping by using the Top-K beams (Top-K beam sweeping). A Top-K beam sweeping program may be configured by the gNB. Step S340 is an optional step.

In Step S350, the UE reports beam quality (beam quality report). The UE may report an actual top 1 beam, or may report indexes and L1-RSRPs of some or all of the K best beams. The UE may reuse a conventional beam reporting mechanism.

In Step S360, the gNB indicates a beam for DL data transmission. The gNB may reuse a conventional TCI beam indication mechanism.

The foregoing describes a procedure of beam management or beam prediction based on an AI/ML model with reference to FIG. 2 and FIG. 3. AI/ML-based beam management enhancements still face some problems that need to be solved or studied.

In an example, when a terminal device processes, by using an AI algorithm, beams detected and measured from a wireless network, to infer other beams that may have higher strength and/or higher quality, the terminal device needs to ensure model consistency between a training phase and an inference phase. As previously described, there is a time interval between the training phase and the inference phase, and changes in radio parameters/conditions may cause errors in the inference phase.

In an example, it may be learned from the foregoing description that the set A usually has a larger quantity of beams than the set B. The set B usually represents a measurement set or a partial set of downlink reference signals, and is used to assist a network side in beam prediction and selection. However, the terminal device may not need to know whether beam sweeping performed by the network device is used for beams in the set A or beams in the set B, or even a non-AI/ML-based BM. Therefore, how the terminal device determines beams in the set B from beams transmitted by the network device is a problem that needs to be resolved.

Based on this, an embodiment of the present application provides a method for wireless communication. In this method, the terminal device may determine, based on first configuration information, an association ID corresponding to the first model, and then select, based on the association ID, a beam set for performing model training and model inference. In other words, the terminal device performs beam measurement and beam prediction based on a same beam ID. When a beam transmission condition changes, the association ID of the beam set is updated, and the terminal device may update the first model based on a new association ID, to improve prediction accuracy.

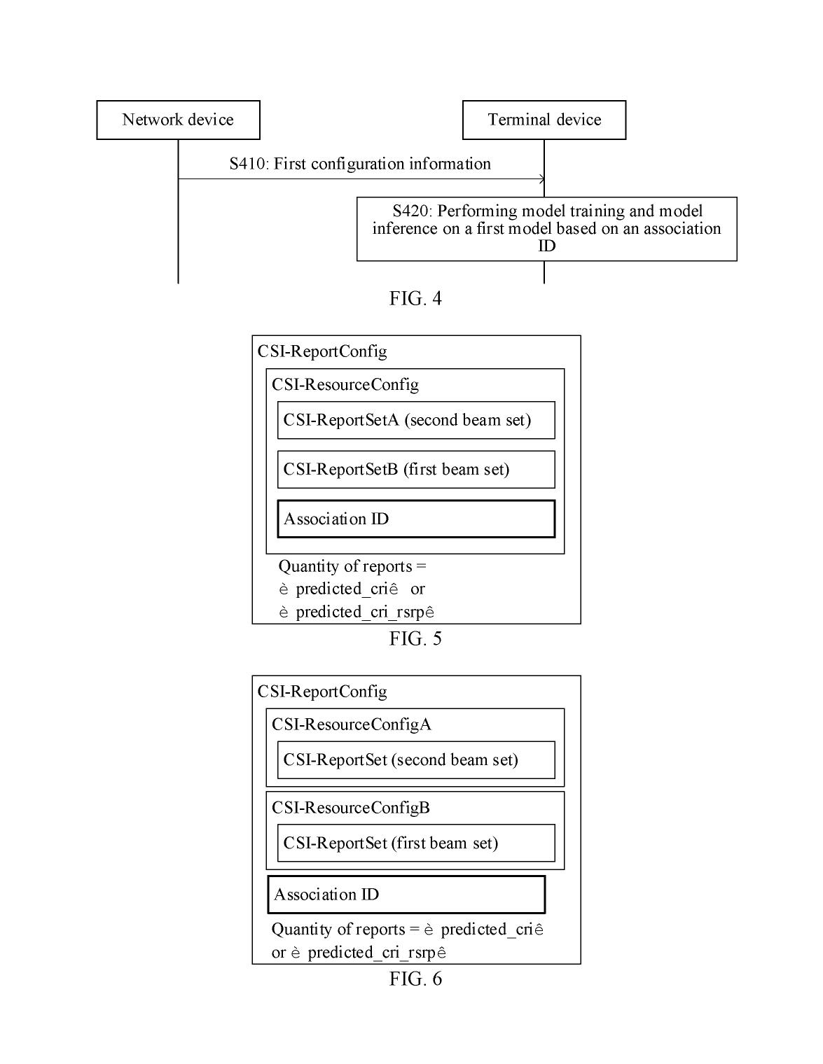

The wireless communication method proposed in this embodiment of the present application is described in detail below with reference to FIG. 4. FIG. 4 is described from a perspective of interaction between a terminal device and a network device.

The terminal device may be any one of the terminal devices described above. For example, the terminal device is a UE.

In some embodiments, the terminal device supports enhanced functionality based on the AI/ML operation. For example, the terminal device has a function of enhancing beam management based on an AI/ML operation.

In some embodiments, a first model is deployed on the terminal device to predict a beam transmitted by the network device or another terminal device. In an example, the first model is a model that supports an AI algorithm or ML, that is, the first model is an AI/ML model.

In an example, beam prediction implemented by the first model may be the BM-Case1or BM-Case2 described above, or may be another future beam prediction type, which is not limited herein.

In some embodiments, the first model is deployed on a terminal device side. In other words, the first model is not located on a terminal device, but on a server communicating with the terminal device. For example, the first model is located on an OTT server directly communicating with the terminal device.

In some embodiments, the first model may be one of a plurality of models deployed on a terminal device side. The first model may correspond to a network device that currently transmits a beam or a beam set to the terminal device, so as to predict a transmit beam of the network device. For example, a plurality of models may be developed on the terminal device side, for example, models 1, 2, 3, and 4. The first model may be any one of four models.

In an example, the plurality of models may be used to predict transmit beams in different scenarios or from different beam transmission devices.

The network device may be any network device that communicates with the terminal device. For example, the network device is a base station.

In some embodiments, the network device may monitor a process in which the terminal device processes the first model. For example, the network device may determine, based on a report transmitted by the terminal device, whether the current stage is a training stage or an inference phase of the first model.

In some embodiments, the network device supports an AI/ML operation. The first model may be deployed on a network device side.

In some embodiments, the network device may transmit a plurality of beams to the terminal device a plurality of times, to facilitate measurement performed by the terminal device, and perform model training and model inference on the first model based on a measurement result.

Referring to FIG. 4, in Step S410, the terminal device receives first configuration information. In an example, the terminal device may receive the first configuration information transmitted by the network device. In an example, the terminal device may receive the first configuration information indicated by higher layer signalling.

The first configuration information is used to indicate an association ID, or may be referred to as a related ID. Consistency during model training and inference may be determined by introducing a mechanism for the association ID. In an example, the association ID may be associated with a beam direction by using a reference signal. The terminal device may estimate a channel state based on CSI-RS signals in different directions. The first model may obtain measurements and association information of different beams by using indexes of the signals, so as to ensure consistency during training and inference.

In an example, in a training and inference process of the first model, the association ID is used to ensure consistency between a first beam set and a second beam set. Different measurement scenarios, mobile environments, and time-varying radio channel characteristics may result in a change in measurement data, so that the association ID can help ensure that the data is consistent and correlated during training and inference.

In an example, the first configuration information may further indicate a related configuration of data collection. The association ID is used for the data collection.

In some embodiments, the first configuration information may directly indicate the association ID. For example, the first configuration information includes the association ID. In some embodiments, the first configuration information may be used to determine the association ID. For example, the first configuration information may instruct the terminal device to determine the association ID based on a cell in which the terminal device is located or a network device corresponding to the terminal device.

In an example, the association ID may be introduced in a plurality of frameworks. The plurality of frameworks may include a CSI framework and another framework related to a beam reference signal. The plurality of frameworks may be further included in or outside a framework. The CSI framework is used as example, and the plurality of frameworks may be included in the CSI framework or outside the CSI framework. In a scenario in which the association ID is introduced in the CSI framework, the association ID may directly be a resource index of CSI, for example, the association ID is CSI-ResourceConfigID. When an association ID is introduced outside the CSI framework, because the association ID corresponds to a “beam-related attribute” of the network device, an indication mechanism of the association ID may be similar to a beam indication, where a TCI state is activated and indicated.

In an example, the association ID may be transmitted and marked with a reference signal carried by a beam. For example, in the CSI framework, the association ID may be transmitted and marked together with a CSI reference signal (CSI-RS), so that the first model can determine a beam selection at both a measurement phase (training phase) and an inference phase by using a same association ID. For another example, the association ID may be transmitted and marked with an SSB.

In the foregoing example, the network device may transmit a plurality of groups of CSI-RSs, and the terminal device receives these signals in different spatial directions. The terminal device may measure channel state information (such as, RSRP or SINR) of each beam, and allocate one association ID (such as a CSI-RS resource index, or a beam ID) to each beam.

In the foregoing example, each CSI resource may correspond to a set of specific resource blocks, symbols, and antenna port combinations for channel measurement and beam selection. The network device may identify these resources by using a CSI resource index (CSI-RS index), thereby indirectly identifying a beam. For example, a CSI resource may correspond to a set of specific resource blocks, for example, H resource blocks, and H is a positive integer. Indexes of resource blocks are sequentially increased in an ascending order, namely, index1, index2, ..., indexH. The terminal device may cause each beam ID in the CSI resource beam group to be associated with a CSI-RS resource index.

In an example, the association ID may be carried in a CSI resource configuration (CSI-ResourceConfig) related to beam transmission, which will be described below with reference to FIG. 5 to FIG. 7 and related embodiments.

In an example, the association ID may be carried in a CSI periodic trigger state list (CSI-AperiodicTriggerStateList), which will be described later with reference to FIG. 8 to FIG. 10 and related embodiments.

In an example, the association ID may be carried in radio resource control (radio resource control, RRC) signalling. For example, when the association ID is an ID of one beam set, the association ID may be carried in the RRC signalling.

In the foregoing example, the network device may configure a list of association IDs by using RRC at the beginning. When the network device selects a new association ID to be used (different from a current association ID), the network device may indicate, to the terminal device, an index of a target association ID in the list by using different signals (such as new downlink control information (downlink control information, DCI)). After receiving the indication message, the terminal device may assume that all RS resources are transmitted by using a new NW configuration. An advantage of this mechanism is that the signalling indicated by the association ID is separated from the signalling triggered by the report. Therefore, when the association ID is indicated in advance, the terminal device may have more time to switch to a corresponding model based on the association ID. In some scenarios, this mechanism may ensure that the terminal device runs only one model at a time.

The association ID is an ID used for the first model and/or a function in the first model described above. In a training and inference process of the first model, the association ID is used to ensure consistency between a measurement beam set and a prediction beam set that correspond to the first model. The measurement beam set may also be referred to as a first beam set, namely, the set B described above. The prediction beam set may also be referred to as a second beam set, namely, the set A described above.

The association ID may include one or more of the following: a set ID used for selecting the first beam set and/or the second beam set; or a beam ID group, including an ID of each beam in the first beam set and/or the second beam set. In other words, the association ID may be classified into a set ID and an ID specific to each beam, which are applied to different scenarios or requirements.

In some embodiments, the set ID may be an ID corresponding to both the first beam set and the second beam set. In other words, the first beam set and the second beam set that correspond to the first model have a same association ID, so that the terminal device performs data collection, training, and inference.

In an example, when the association ID is the set ID, the first configuration information may be transmitted by using a resource index of a beam. For example, when the association ID is the set ID, the first configuration information is carried in resource configuration information of the first beam set and/or the second beam set.

In the foregoing example, the first configuration information may be carried in one type of the following information: resource configuration information shared by the first beam set and the second beam set; a configuration report shared by the first beam set and the second beam set; or first resource configuration information corresponding to the first beam set and second resource configuration information corresponding to the second beam set.

Resource configuration information of a CSI-RS is used as an example, and the resource configuration information may be indicated by using CSI-ResourceConfig. Each CSI-RS resource has its unique ID (a CSI-RS resource index). Information about the ID may correspond to the association ID. The first model may identify CSI-RS measurements associated with different beam directions by using the index.

In an example, the first configuration information may be carried in a trigger list related to a first report, and the first report is determined based on an inference result of the first model. For example, to reduce use of CSI-ResourceConfig, the network device may transmit the first configuration information when the first report is triggered/activated, so as to allocate/indicate the association ID. The association ID is then shared in the first report that is triggered/activated.

In the foregoing example, the first configuration information may be carried in one type of information of the following trigger list: a general list of related report configuration information; or a first related report configuration information list corresponding to the first beam set and a second related report configuration information list corresponding to the second beam set.

In some embodiments, the beam ID group may include an ID specific for each beam in the first beam set and/or the second beam set. In some scenarios, according to configuration of the beam ID group, the terminal device selects a proper model to perform beam prediction.

In an example, it is assumed that there are two different base station code beam (code beam, CB) configurations on an NW side, namely, a CB1 and a CB2. Without knowing a configuration of a base station code beam, the terminal device side may develop models 1, 2, 3, and 4. Each model is developed based on some assumed base station beam shapes. For example, it is assumed that the model 1 is exactly applicable to the CB1 (perhaps because an assumed base station beam shape in training of the model 1 matches that of the CB1), and the model 2 is exactly applicable to the CB2. It is assumed that the base station uses the CB1 in an inference process. Before inference, the terminal device needs to blindly attempt all four models and monitor performance of the models. The model 1 continues to be used during inference when the terminal device finds that the model 1 runs well. It should be understood that there is no model identity in this scenario. The NW does not know that there are four models at the terminal device, and the models 1 to 4 are only internal models at the terminal device side. Obviously, this monitoring-based trial-and-error approach is inefficient because it generates overheads in terms of latency and power consumption of the terminal device. During model training, a beam shape assumed by the terminal device may not further match a codebook of an actual base station. Thus, compared with another solution based on offline/over-the-air alignment or model transmission, a solution of selecting the best model based on monitoring may have poor performance. For this problem, an ID specific to each beam is introduced as an identity for model training and inference.

In an example, when the association ID is the beam ID group, the beam ID group is represented by using a beam association ID matrix, and the beam association ID matrix is used to indicate a mapping relationship between the first beam set and the second beam set.

In the foregoing example, a beam direction identifier (for example, a beam ID) may be used to identify and measure an ID of each beam in the first beam set. To better determine the relationship between the first beam set and the second beam set, the network device may construct a beam association ID matrix M, to represent the mapping relationship between the first beam set and the second beam set. For example, each element M(i, j) in the matrix M may represent a correlation between a beam Bi in the first beam set (set B) and a beam Aj in the second beam set (set A). Based on a machine learning method, the beam association ID matrix may be learned in a training process, and beam prediction may be performed by using the matrix during inference.

It should be understood that, in a wireless communications system, a channel state varies with time. Therefore, the association ID relationship between the first beam set and the second beam set may vary over time. For this problem, the terminal device may use a sliding window policy. Based on the sliding window policy, the terminal device may update the beam association ID in real time based on latest CSI-RS measurement data. After each update, the network device and the terminal device may communicate with each other by using the latest association ID.

In the foregoing example, for the matrix M, the terminal device may calculate a spatial correlation between beams by using historical measurement data. If the beams Bi and Aj exhibit similar channel states (such as RSRP values) in past measurements, M(i, j) has larger correlation values.

In an example, the beam association ID matrix is determined based on a resource index of the first beam set and a resource index of the second beam set. In other words, the beam association ID matrix may correspond to a resource index matrix of the first beam set and the second beam set. For example, the network device may construct a beam association ID matrix M1 based on a CSI beam resource index, which represents a mapping relationship between two beam sets. Each element M1(i, j) in a matrix M1 may represent a correlation between each beam resource index in the first beam set and a beam Aj in the second beam set.

In some embodiments, the association ID may include a set ID and a beam ID group. For example, an ID of the entire beam ID group is a set ID.

In some embodiments, the association ID for the model training and inference phases remains unchanged. In an example, when the terminal device measures the first beam set at different instants and performs AI/ML inference, it is generally considered that an association ID in a time-varying channel may still be the same as that in a training phase. To remain the association ID unchanged, spatial-temporal correlation and beam feature stability need to be ensured. The spatial-temporal correlation refers to that channel time-variability is relatively small in a relatively short time scale. In this scenario, a measurement (the first beam set) of the terminal device is associated with the training data, and inference is allowed in a same beam association ID matrix. The beam feature stability means that some beam IDs or beam directions may be relatively stable to a specific terminal device in a specific time. In this scenario, it is assumed that in the inference phase, an environment of the terminal device is similar to that during training, beam correlation remains, and an association ID matrix does not change significantly.

In some embodiments, the environment in the model training phase and inference phase changes, but the change is small and the association ID does not need to be updated. Optionally, whether to adjust the association ID may be determined based on one or more of the following information: a time interval between the model training and the model inference; channel time-variability corresponding to the model training and the model inference; or whether a beam feature of the first beam set and a beam feature of the second beam set are stable. When the time interval is small, or when the channel time-variability is not obvious, or when the beam feature is stable, the association ID is not adjusted even if the environment changes.

In some embodiments, the association ID is used for a model of any of a plurality of updated versions of the first model. In an example, after the association ID is used for model training for the first model, the first model corresponds to the association ID in a subsequent inference process. However, once the first model is trained and updated based on a new association ID, the association ID corresponding to the first model is a new association ID, not the previous association ID.

In some embodiments, the association ID may be determined based on a large quantity of static IDs pre-configured by the network device. The first configuration information may be used by the terminal device to determine, in the large quantity of static IDs, the association ID corresponding to the first model.

In some embodiments, the association ID may be dynamically configured to avoid an infinite increase in the quantity of association IDs. For example, in one NW, there may be a plurality of groups of NW side-related configurations, which are used for different cells on the NW side. In addition, a new NW side-related configuration or a new environment change may occur over time, which causes the trained first model no longer feasible.

In an example, the network device may dynamically generate the association ID based on a network requirement and network load of a cell. In other words, the association ID is dynamically generated according to a current network requirement and a user connection status, so as to avoid generating a large quantity of static IDs for each possible configuration or scenario in advance.

In an example, the network device generates a specific quantity of association IDs in advance, and configures that a new association ID is generated in a first scenario. For example, the network device generates a new association ID only when a specific configuration or region changes, rather than generating an association ID in advance for each possible case.

In an example, to reduce a quantity of pre-configured association IDs, the association IDs may be reused based on adjacent areas on a geographic or network topology. For example, between a plurality of tracking area update (tracking area update, TAU) areas, some specific association IDs may be reused in a same type of network configuration or similar network configuration, thereby reducing the quantity of association IDs.

In an example, the network device may perform classification and hierarchical management on the association IDs according to different network configuration levels. The network configuration level may include a core network configuration, an RAN configuration, a user plane configuration, or the like. In this manner, association IDs of different ranges may be allocated at different levels, reducing a quantity of association IDs required at each layer.

In an example, in a scenario in which a quantity of association IDs is determined, a representation length of the association ID is reduced to reduce signalling overheads. For example, a large range of association IDs is mapped to shorter bits by using a shorter identifier or a hash function, so that sizes of the association IDs may be significantly reduced during signalling transmission, thereby reducing signalling load.

In an example, the network device triggers transmission of the first configuration information based on a second-type trigger event. In other words, the network device may update the association ID in an event-triggered manner. The second-type trigger event may be a specific event such as a user location change or a service requirement change.

In some embodiments, the association ID is associated with a cell in which the terminal device is located. In other words, the association ID indicated by the first configuration information is a cell association ID. An ID (for example, a physical cell identity (physical cell identity, PCI)) of each cell may correspond to an association ID of each cell. For example, the association ID may be only a number between 0 to N. For another example, the association ID may be associated with a PCI.

In an example, the association ID may remain in an NW. The network device may initiate a data collection session, and allocate an identifier (such as an association ID) for the data collection session. The terminal device may collect data belonging to the association ID. For example, in response to a request from the terminal device, the network device may initiate the data collection session. In the request, the terminal device may indicate a preference for the set A and the set B.

In an example, the association ID may be adjusted according to a network requirement and network load of a cell. The association ID corresponding to the first model is not static or unchanged, but may be updated depending on changes in a network environment to avoid prediction errors. When the association ID is updated, the first configuration information may be used by the terminal device to determine an updated association ID and determine whether to update the first model.

In some embodiments, the association ID is related to a transmitting device of a prediction beam of the first model. In an example that the first model is used to predict a transmit beam of the network device, the association ID is related to an additional condition on a network (NW) side, which helps identify a beam transmitting device based on the association ID.

In an example, as time elapses, the network device may transmit a corresponding association ID to the terminal device as long as additional conditions on the NW side are the same, so that the terminal device can collect more data. The terminal device side may collect data over time by using the received association ID to train the first model. Once the first model is adequately trained, the terminal device may notify the network device that the first model is ready for inference. Then, whenever an additional condition on the NW side in an inference process matches an additional condition in a training data collection process, a corresponding association ID is used to transmit a signal to the terminal device from the network device, so that the terminal device may apply the first model obtained after corresponding training to the specific association ID.

In an example, an additional condition related to the association ID may include NW side-specific information. The NW side-specific information may be related to a beam transmission parameter and/or a beam transmission resource. For example, the NW side-specific information may include a 3dB beam width, a beam aiming direction, a beam angle, a transmission filter, a corresponding resource sequence (corresponding to a beam) of the first beam set or the second beam set, Tx power, an antenna height, an antenna downward tilt parameter, a deployment scenario, or the like.

In an example, when performing access, the terminal device may report one or more association IDs corresponding to the first model. In a scenario in which the network device is a base station, if the terminal device accesses a base station B, and the base station B and a base station A that are accessed last time have different additional conditions on the NW side, the terminal device needs to report an association ID. The base station B needs to identify an NW side additional condition corresponding to the association ID. In some scenarios, different base stations may identify additional conditions corresponding to different association IDs. However, this may be difficult between different base station vendors.

In some embodiments, the association ID configured on the network side may have a plurality of correspondences with the network device to adapt to different application scenarios.

In an example, the association ID is one of a plurality of association IDs, and the plurality of association IDs are in a one-to-one correspondence with a plurality of network devices. For example, each base station is configured with a unique association ID, so as to identify the base station based on the association ID. In this example, the plurality of network devices may belong to a same vendor or may belong to different vendors. A plurality of association IDs corresponding to a same vendor belong to one ID group.

In the foregoing example, different base station vendors should use different sets of association IDs. A base station vendor may allocate a base station-specific ID/ID set to each base station. If a base station receives an association ID from the terminal device, and the association ID does not belong to an association ID set of the base station vendor, the base station does not transmit an inference configuration of the first model on the side of the terminal device.

In an example, the association ID is one of a plurality of association IDs, and the plurality of association IDs correspond to one network device. For example, the plurality of association IDs may be configured in one cell, and therefore, a network device of the cell corresponds to the plurality of association IDs.

In an example, when the association ID is a set ID, the association ID may be a global association ID. The global association ID may correspond to an ID of one TAU area. Optionally, the association ID may correspond to one or more network devices in a first TAU area. In other words, a plurality of network devices in the first TAU area are configured with a same association ID. It should be noted that each TAU area usually has one area ID. When the plurality of network devices correspond to one association ID, different network devices may be distinguished from each other by using an area ID of a TAU area and a PCI.

In Step S420, the terminal device performs model training and model inference on the first model based on the association ID. In other words, the terminal device may perform training and inference on the first model based on a same association ID.

In some embodiments, after the NW transmits data collection-related configuration and an association ID thereof, the terminal device collects data corresponding to the association ID, and trains the first model based on the collected data corresponding to the association ID. For example, the first beam set includes all measured beam information, and each beam forms input data of the first model together with its measurement and association ID. Based on historical measurement data of the first beam set, the first model is established and trained to predict a future best beam of the second beam set.

In some embodiments, in the inference process, an association ID of a beam in the first beam set and a beam in the second beam set needs to be defined for correctness of input and prediction of the first model. The association ID may be considered as a bridge established between a set of different measurements (for example, the first beam set) and a set of beam prediction results (for example, the second beam set).

In some embodiments, the association ID needs to be maintained. For example, it is assumed that the terminal device collects a data set by using an association ID from the cell and trains its model. After a long time, when the terminal device re-enters the cell, the NW may have changed its NW-related configuration and mapping of a terminal device ID of each cell. However, in a case in which ID values are the same, the terminal device still considers a model of the terminal device to be feasible. In this case, because the network configuration has changed, if the terminal device deems that the first model is still valid, a prediction error may occur. Therefore, in this case, the first model actually needs to be retrained or updated.

Optionally, the change of the network configuration may include an antenna downtilt angle change, an antenna quantity change, a beam coverage shape change, a beam structure change, another network condition change, or the like.

Optionally, whether to updated the first model may be determined based on a first-type trigger event. The first-type trigger event includes one or more of the following: a hash value bound to the association ID changes; RRC signalling indicates that or the terminal device determines that a network configuration corresponding to the association ID changes; a change range of a network configuration exceeds a set threshold; or at least one of a location or an association ID obtained after the terminal device re-accesses a cell changes.

In an example, a current configuration of the network device may generate a hash value and bind the hash value to the association ID. The terminal device may store a hash value used during training, and compare the stored hash value with a current hash value during inference. If the hash value changes, that is, a configuration changes, update of the first model is triggered.

In an example, the network device may explicitly notify, by using RRC signalling, that the configuration of the terminal device changes, and recommend that the first model should be updated. This method may ensure that the terminal device can update the first model in a timely manner without relying on passive observation of the terminal device.

In an example, the terminal device may determine, based on a manner such as self-model verification or comparison environment information, whether a network configuration corresponding to the association ID changes. For example, the terminal device may periodically perform self-model verification, to determine whether there is a significant difference based on a change of network performance (such as throughput, delay, or channel quality) in an inference process. If an inference result does not match expected model performance, retraining and updating of the first model may be triggered. For another example, the terminal device may record, during training, environment information (such as signal strength or channel state) related to a network, and compare the information during inference. If there is a large difference, it may be inferred that a change occurs on the network configuration, thereby triggering model retraining or update.

In an example, the terminal device may determine, based on a change range of the network configuration, whether fine-tuning is required for the model. When the change range of the network configuration exceeds or is equal to a specified threshold, the first model is to be retrained and updated; when the change range of the network configuration is less than the specified threshold, no retraining or update is to be performed on the first model at present. For example, for a small network condition change, the terminal device may perform fine-tuning on the model in an incremental learning (incremental learning) manner. For another example, for change thresholds of some key parameters (such as an antenna downtilt, a beam intensity, and the like), when the change is within a range, the terminal device only needs to perform fine-tuning, rather than completely reconstruct the model.

In an example, the network device may classify degrees of the change of the network configuration, and notify the terminal device by using the RRC signalling. For example, when the network configuration changes slightly, the network device may mark the change as “slight change”, to indicate that the terminal device only needs to perform local model fine-tuning. When the network configuration changes significantly, the network device may mark the change as “significant change”, to instruct the terminal device to perform complete model update or retraining.

In an example, the terminal device may determine, depending on a change of a location of the terminal device and/or the association ID, whether to update the first model. For example, the association ID corresponds to beam ID information. If the location of the terminal device is not changed in a period of time or the terminal device is still nearby the original location after re-accessing a cell, and the terminal device also corresponds to same beam ID information, the terminal device does not trigger update of the first model. If the terminal device is still nearby the original location after re-accessing a cell, but has different beam ID information, the terminal device triggers update of the first model. If the terminal device is not nearby the original location after re-accessing a cell and has different beam ID information, the terminal device triggers update of the first model; if the terminal device is not nearby the original location after re-accessing a cell and has same beam ID information, the terminal device does not trigger update of the first model.

In an example, the terminal device may update the first model in real time or dynamically. The update of the first model may include a local parameter update of the first model. For example, in a case in which a beam shape changes, the terminal device may collect inference data in real time and perform local model parameter update without large-scale model retraining. For another example, the terminal device may dynamically adjust the model depending on a change of a physical condition (for example, change of signal strength or interference level) in an environment. In this case, the terminal device does not rely entirely on configuration notification from the network device, but automatically adjusts a model parameter to adapt to a new network condition by sensing and measuring a local environment.

In an example, the terminal device may be one of a plurality of terminal devices participating in federated learning. When the first model is a local model in federated learning, the terminal device may transmit update information of the first model to another terminal device in the plurality of terminal devices. For example, the terminal device may share update of a local model of the terminal device with a network end (or the another terminal device) by using federated learning, so as to perform cooperative learning when a network condition changes. In this way, the plurality of terminal devices may collaboratively update the model in different network conditions, thereby avoiding a case that a single terminal device performs all model update tasks, and improving fine-tuning efficiency of the model.

The foregoing describes, with reference to FIG. 4, method embodiments in which the association ID is used to ensure consistency between a training phase and an inference phase. It may be learned from the foregoing that the association ID may be indicated by using resource configuration information or a trigger list related to a first report. With reference to embodiments illustrated in FIG. 5 to FIG. 10, the first configuration information may be transmitted in a plurality of manners.

FIG. 5 to FIG. 7 show a plurality of possible manners of configuring an association ID of a first beam set (set B) and an association ID of a first beam set (set A) in CSI-ResourceConfig. The configuration manner is configured based on a CSI-RS resource index, so as to perform model inference. In FIG. 5 to FIG. 7, a quantity of reports is determined based on a parameter “predicted_cri” or “predicted_cri_rsrp”.

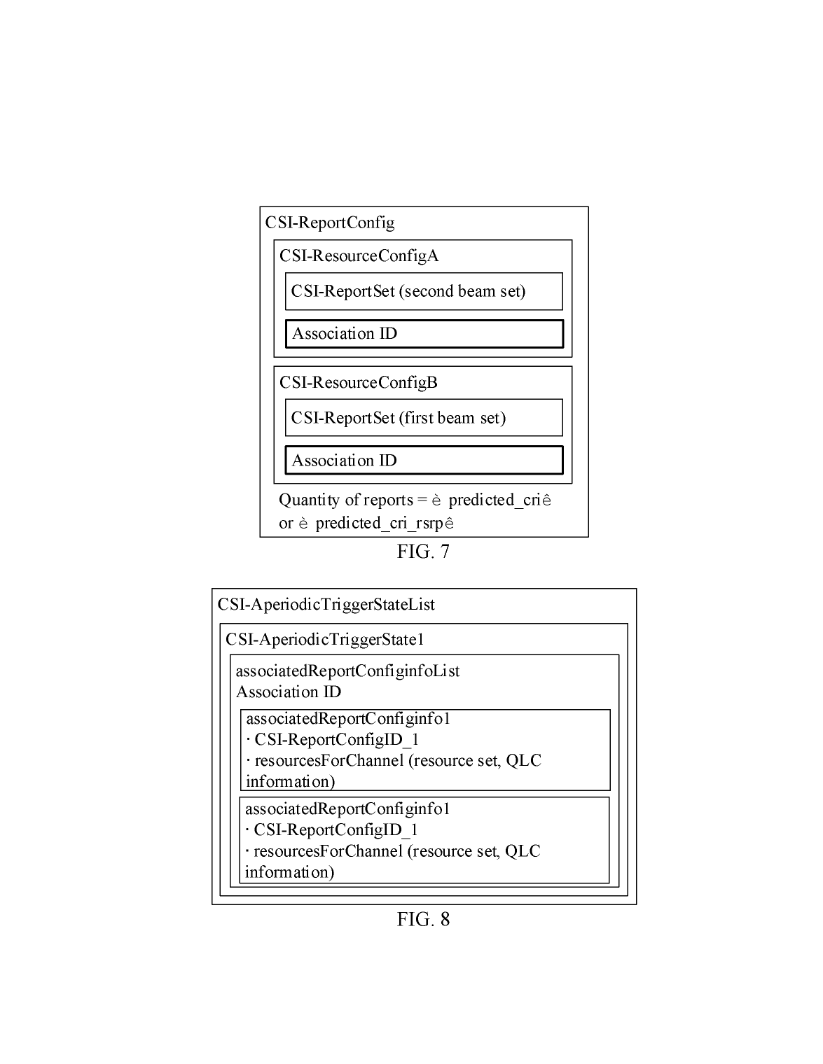

Referring to FIG. 5, the first beam set and the second beam set are configured in a same CSI resource configuration parameter (CSI-ResourceConfig) in CSI-ReportConfig, and an association ID is also in the resource configuration parameter. Referring to FIG. 6, the first beam set and the second beam set are configured as different CSI resource sets in CSI-ReportConfig, that is, different CSI-ResourceConfig. However, the two resource sets share a same association ID indicated in CSI-ReportConfig. Compared with FIG. 6, the first beam set and the second beam set in FIG. 7 are configured with different CSI resource sets, and each resource set indicates one association ID.

It may be learned from FIG. 5 to FIG. 7 that, the association ID in FIG. 5 or FIG. 6 is shared between the first beam set and the second beam set. Compared with FIG. 6 and FIG. 7, resource sets of the first beam set and the second beam set are configured independently. However, two association IDs in FIG. 7 respectively correspond to different CSI-ResourceConfigID (namely, CSI-ResourceConfigA and CSI-ResourceConfigB), and the one association ID in FIG. 6 is configured in CSI-ReportConfig. Based on different configuration manners in FIG. 6 and FIG. 7, each CSI-ResourceConfigID in FIG. 6 may construct one CSI-ResourceConfig, or may be configured in different CSI-ReportConfig; and in FIG. 7, an association ID is configured in each CSI-ResourceConfigID, and thus different association IDs are not required to be additionally indicated in CSI-ReportConfig, which is more beneficial in reporting configuration overheads.

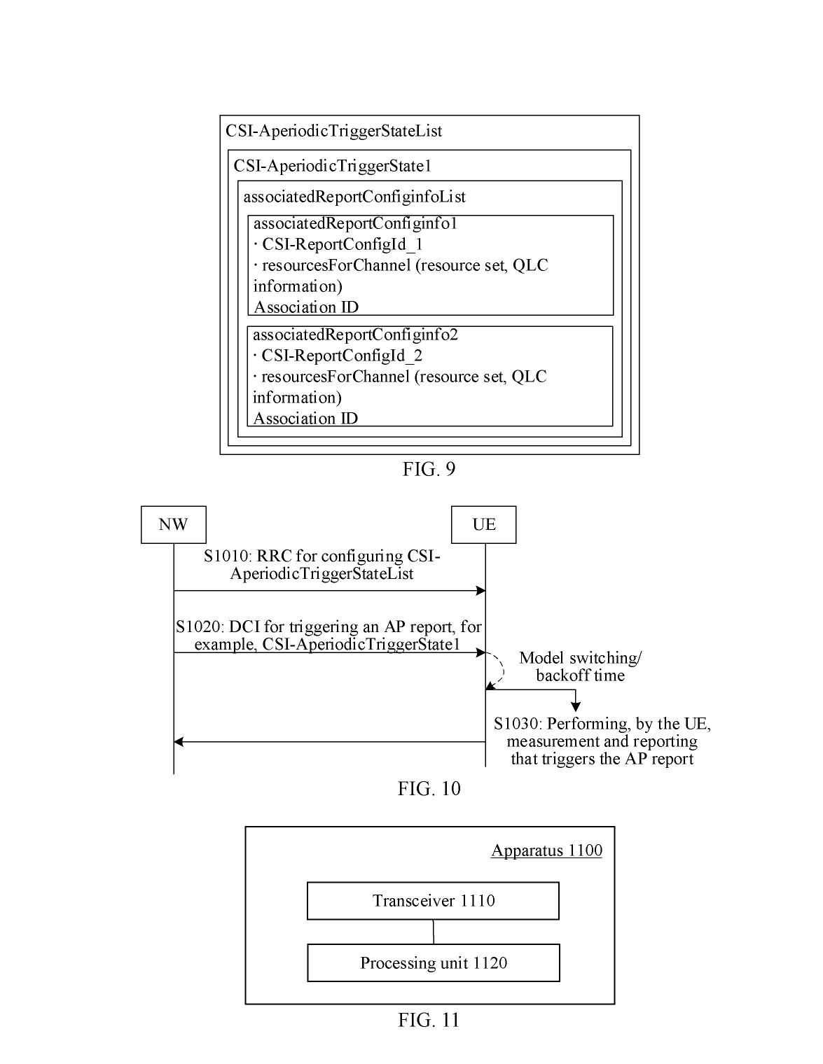

FIG. 8 and FIG. 9 show a plurality of possible manners of configuring an association ID during triggering of an aperiodic (aperiodic, AP) report. FIG. 8 and FIG. 9 are two examples of how to indicate an association ID in a plurality of reports when a group of aperiodic reports is triggered.

FIG. 8 shows that further grouping is performed in CSI-AperiodicTriggerStateList after CSI-ReportConfig is configured in a CSI framework. CSI-AperiodicTriggerStateList is a list of CSI. In each CSI aperiodic trigger state, there is an associated ReportConfigInfoList (namely, associatedReportConfigInfoList). This list includes an associated ReportConfigInfo list, and each associated ReportConfiginfo includes CSI-ReportConfigID and related resource set (ResourceSet) and quasi co-location (QCL) information used by CSI-ReportConfig.

Optionally, an NW may indicate CSI-AperiodiodicTriggerState in CSI-AperiodicTriggerStateList by using DCI, and then all CSI-ReportConfig information included in CSI-AperiodisTriggerState is triggered.

To indicate an association ID of a report, the association ID may be configured in CSI-AperiodicTriggerState. For example, the association ID may be configured directly in associatedReportConfigInfoList, and a same association ID may be shared among a plurality of CSI-ReportConfig, as shown in FIG. 8. Alternatively, an association ID may be configured in each associated ReportConfigInfo. Therefore, each CSI-ReportConfig has a dedicated association ID, as shown in FIG. 9.

FIG. 10 shows an entire interaction process between an NW and a UE in a current aperiodic (AP) report triggering method. In Step S1010, an association ID is configured with an RRC signal for configuring CSI-AperiodicTriggerStateList. CSI-ReportConfig does not change between different association IDs. In Step S1020, DCI may be used for triggering an AP report, for example, CSI-AperiodicTriggerState. The NW may indicate the association ID in an aperiodic trigger report. For all alternative solutions for configuring an association ID in a CSI framework, the NW may simultaneously configure reports that require different association IDs. In Step S1030, if the UE is triggered by the reports, the UE performs measurement and reporting that triggers the AP report. As shown in FIG. 10, there is a model switching/backoff time between Step S1020 and Step S1030. A terminal device may need to run a plurality of models simultaneously or switch frequently between models to generate a corresponding beam report by using a correct model.

The foregoing describes a method for indicating an association ID based on resource configuration information or a report trigger list. The following uses a beam bearer CSI-RS as an example to describe a method for configuring a first beam set and a second beam set resource by a network device.

In some embodiments, for a model on a terminal device side, the network device needs to configure a first beam set for measurement, and configure a second beam set for prediction and reporting. The two beam sets may be associated in a plurality of manners. Optionally, the network device may provide four options to configure an association between a beam in the first beam set and a beam in the second beam set for reporting an inference result.

In an example, when the first beam set and the second beam set are used to transmit a CSI-RS, a resource of the first beam set is indicated by using a first parameter, and a resource of the second beam set is indicated by using a second parameter. The first parameter and the second parameter include one of the following: the first parameter and the second parameter are different CSI-ResourceConfigID; the first parameter and the second parameter are same CSI-ResourceConfigID; the first parameter is CSI-ResourceConfigID, and the second parameter is a configuration parameter of a plurality of resource sets; or the first parameter is a specific information element (information element, IE) of the first beam set, and the second parameter is CSI-RS-ResourceSetList.

In an embodiment, the network device configures CSI-ResourceConfigID for each of the first beam set and the second beam set (as shown in FIG. 6 or FIG. 7). The first beam set and the second beam set need separate resource sets to distinguish between a resource for measurement and a resource for prediction. A terminal device needs to report a measurement result of the second beam set and a measurement result of the first beam set, and the network device may evaluate, based on the measurement result of the first beam set, whether a prediction result of the second beam set is accurate. The network device may further determine whether to use the measurement result of the first beam set or the measurement result of the second beam set obtained after machine learning. The terminal device needs to associate two CSI-ReportConfig to learn which beam set is used for reporting.

In an embodiment, the network device configures one CSI-ResourceConfigID for the first beam set and the second beam set (as shown in FIG. 5), that is, configures a resource set of the first beam set and a resource set of the second beam set in same CSI-ResourceConfigId. Although the resource sets are configured in one CSI-ResourceConfigID, a report configuration of two beam sets may be supported. For example, the first beam set and the second beam set may separately use different CSI-ReportSet. In other words, a separate resource set is configured for each of the first beam set and the second beam set, and the terminal device may easily distinguish between a resource used for measurement and a resource used for prediction.

In an embodiment, the network device configures one CSI-ResourceConfigID for the first beam set; and the second beam set is configured by a plurality of resource sets, and may be a virtual set. This may be achieved by simply extending a quantity of configurable resource sets in a resource setting. In this embodiment, the second beam set cannot be configured by using a CSI resources/ResourceSet/ResourceConfig because these IEs are defined based on a CSI resource, and a physical mapping of resources is specified. The second beam set is always configured with a corresponding resource ID/resource set ID/ResourceConfigID for training and performance evaluation. The second beam set may further be determined from an associated function/association ID.

In an embodiment, the second beam set may be configured by using existing CSI-RS-ResourceSetList. The first beam set may be configured by using a new IE in a form of a bitmap, a bitmap ID, a group of RS IDs, or a resource set ID.

The foregoing describes the method embodiments of the present application in detail with reference to FIG. 1 to FIG. 10. The following describes in detail the apparatus embodiments of the present application with reference to FIG. 11 to FIG. 13. It should be understood that the description of the apparatus embodiments corresponds to the description of the method embodiments. Therefore, for parts that are not described in detail, one may refer to the foregoing method embodiments.

FIG. 11 is a schematic block diagram of a wireless communication apparatus according to an embodiment of the present application. The apparatus 1100 may be any terminal device described above. The apparatus 1100 shown in FIG. 11 includes a transceiver unit 1110 and a processing unit 1120.

The transceiver unit 1110 may be configured to receive first configuration information, where the first configuration information is used to indicate an association ID; and a processing unit 1120 may be configured to perform model training and model inference on a first model based on the association ID. The first model corresponds to a first beam set and a second beam set, and the association ID includes one or more of the following: a set ID used for selecting the first beam set and/or the second beam set; or a beam ID group, including an ID of each beam in the first beam set and/or the second beam set.

Optionally, the association ID is one of a plurality of association IDs, and the plurality of association IDs are in a one-to-one correspondence with a plurality of network devices.

Optionally, the association ID is a set ID, and the association ID corresponds to one or more network devices in a first TAU area.

Optionally, the association ID is one of a plurality of association IDs, and the plurality of association IDs correspond to one network device.

Optionally, the association ID is related to a cell in which the terminal device is located, and the association ID is adjusted depending on a network requirement and network load of the cell.

Optionally, the association ID is a set ID, and the first configuration information is carried in resource configuration information of the first beam set and/or the second beam set.

Optionally, the first configuration information is carried in one type of the following information: resource configuration information shared by the first beam set and the second beam set; a configuration report shared by the first beam set and the second beam set; or first resource configuration information corresponding to the first beam set and second resource configuration information corresponding to the second beam set.

Optionally, the transceiver unit 1110 is further configured to transmit a first report based on an inference result of the first model. The association ID is a set ID, and the first configuration information is carried in a trigger list related to the first report.

Optionally, the first configuration information is carried in one type of the information of the following trigger list: a general list of related report configuration information; or a first related report configuration information list corresponding to the first beam set and a second related report configuration information list corresponding to the second beam set.

Optionally, the association ID is a set ID, and the association ID is carried in RRC signalling.

Optionally, the association ID is a beam ID group, the beam ID group is represented by using a beam association ID matrix, and the beam association ID matrix is used to indicate a mapping relationship between the first beam set and the second beam set.

Optionally, the beam association ID matrix is determined based on a beam resource index of the first beam set and the second beam set.

Optionally, whether to adjust the association ID is determined based on one or more of the following information: a time interval between the model training and the model inference; channel time-variability corresponding to the model training and the model inference; or whether a beam feature of the first beam set and a beam feature of the second beam set are stable.

Optionally, the first beam set and the second beam set are used to transmit a CSI-RS, a resource of the first beam set is indicated by using a first parameter, a resource of the second beam set is indicated by using a second parameter, and the first parameter and the second parameter include one of the following: the first parameter and the second parameter are different CSI-ResourceConfigID; the first parameter and the second parameter are same CSI-ResourceConfigID; the first parameter is CSI-ResourceConfigID, and the second parameter is a configuration parameter of a plurality of resource sets; or the first parameter is a specific information element of the first beam set, and the second parameter is CSI-RS-ResourceSetList.

Optionally, whether to update the first model may be determined based on a first-type trigger event, and the first-type trigger event includes one or more of the following: a hash value bound to the association ID changes; RRC signalling indicates that or the terminal device determines that a network configuration corresponding to the association ID changes; a change range of a network configuration exceeds a set threshold; or at least one of a location or an association ID obtained after the terminal device re-accesses a cell changes.

Optionally, the first model is a local model in federated learning, the terminal device is one of a plurality of terminal devices participating in the federated learning, and the transceiver unit is further configured to transmit update information of the first model to another terminal device in the plurality of terminal devices.

Optionally, the first model is an artificial intelligence or a machine learning model.

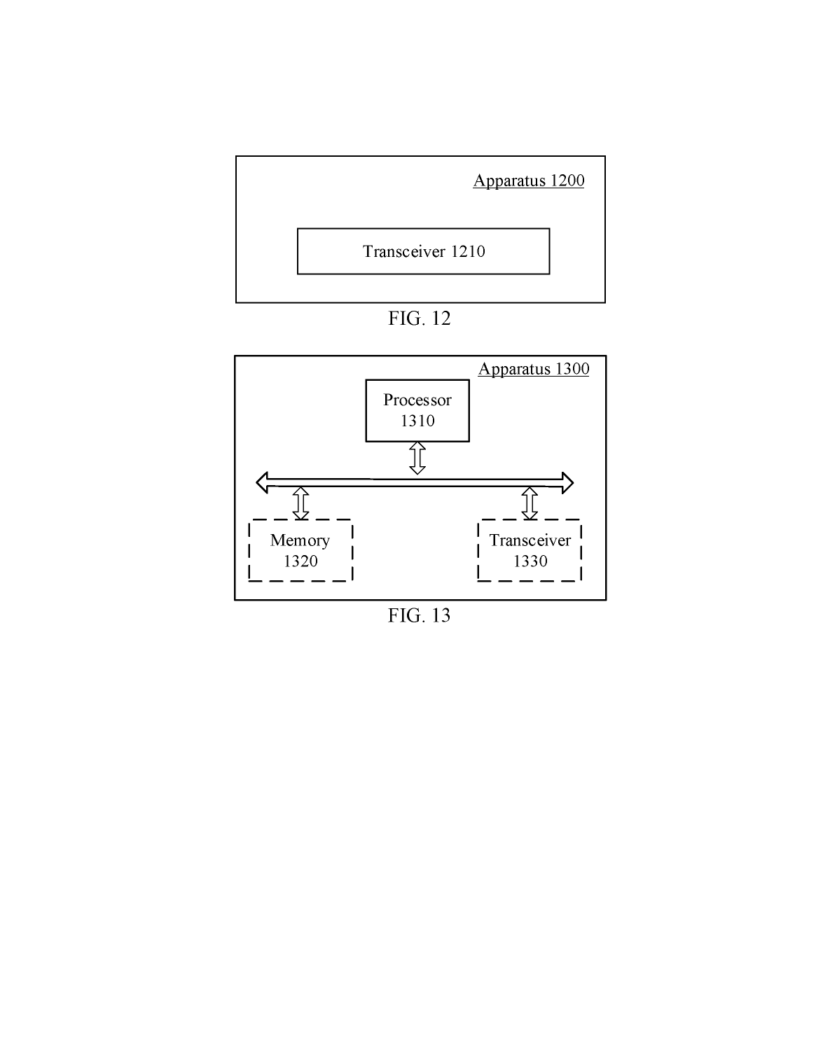

FIG. 12 is a schematic block diagram of another wireless communication apparatus according to an embodiment of the present application. The apparatus 1200 may be any network device described above. The apparatus 1200 shown in FIG. 12 includes a transceiver unit 1210.

The transceiver unit 1210 may be configured to transmit first configuration information, where the first configuration information is used to indicate an association ID. The association ID is used by a terminal device to perform model training and model inference on a first model, the first model corresponds to a first beam set and a second beam set, and the association ID includes one or more of the following: a set ID used for selecting the first beam set and/or the second beam set; or a beam ID group, including an ID of each beam in the first beam set and/or the second beam set.

Optionally, the association ID is one of a plurality of association IDs, and the plurality of association IDs are in a one-to-one correspondence with a plurality of network devices.

Optionally, the association ID is a set ID, and the association ID corresponds to one or more network devices in a first TAU area.

Optionally, the association ID is one of a plurality of association IDs, and the plurality of association IDs correspond to one network device.

Optionally, the association ID is related to a cell in which the terminal device is located, and the association ID is adjusted depending on a network requirement and network load of the cell.

Optionally, the association ID is a set ID, and the first configuration information is carried in resource configuration information of the first beam set and/or the second beam set.

Optionally, the first configuration information is carried in one type of the following information: resource configuration information shared by the first beam set and the second beam set; a configuration report shared by the first beam set and the second beam set; or first resource configuration information corresponding to the first beam set and second resource configuration information corresponding to the second beam set.

Optionally, the transceiver unit 1210 is further configured to receive a first report transmitted by the terminal device based on an inference result of the first model. The association ID is a set ID, and the first configuration information is carried in a trigger list related to the first report.

Optionally, the first configuration information is carried in one type of information of the following trigger list: a general list of related report configuration information; or a first related report configuration information list corresponding to the first beam set and a second related report configuration information list corresponding to the second beam set.

Optionally, the association ID is a set ID, and the association ID is carried in RRC signalling.

Optionally, the association ID is a beam ID group, the beam ID group is represented by using a beam association ID matrix, and the beam association ID matrix is used to indicate a mapping relationship between the first beam set and the second beam set.

Optionally, the beam association ID matrix is determined based on a beam resource index of the first beam set and the second beam set.

Optionally, whether to adjust the association ID is determined based on one or more of the following information: a time interval between the model training and the model inference; channel time-variability corresponding to the model training and the model inference; or whether a beam feature of the first beam set and a beam feature of the second beam set are stable.

Optionally, the first beam set and the second beam set are used to transmit a CSI-RS, a resource of the first beam set is indicated by using a first parameter, a resource of the second beam set is indicated by using a second parameter, and the first parameter and the second parameter include one of the following: the first parameter and the second parameter are different CSI-ResourceConfigID; the first parameter and the second parameter are same CSI-ResourceConfigID; the first parameter is CSI-ResourceConfigID, and the second parameter is a configuration parameter of a plurality of resource sets; or the first parameter is a specific information element of the first beam set, and the second parameter is CSI-RS-ResourceSetList.

Optionally, whether to update the first model may be determined based on a first-type trigger event, and the first-type trigger event includes one or more of the following: a hash value bound to the association ID changes; RRC signalling indicates that or the terminal device determines that a network configuration corresponding to the association ID changes; a change range of a network configuration exceeds a set threshold; or at least one of a location or an association ID obtained after the terminal device re-accesses a cell changes.

Optionally, the first model is a local model in federated learning, the terminal device is one of a plurality of terminal devices participating in the federated learning, and update information of the first model is transmitted to another terminal device, different from the terminal device, in the plurality of terminal devices.

Optionally, the first model is an artificial intelligence or a machine learning model.

FIG. 13 is a schematic structural diagram of a communications apparatus according to an embodiment of the present application. Dashed lines in FIG. 13 indicate that a unit or module is optional. The apparatus 1300 may be configured to implement the methods described in the foregoing method embodiments. The apparatus 1300 may be a chip, a terminal device, or a network device.

The apparatus 1300 may include one or more processors 1310. The processor 1310 may support the apparatus 1300 in implementing the methods described in the foregoing method embodiments. The processor 1310 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1300 may further include one or more memories 1320. The memory 1320 stores a program, where the program may be executed by the processor 1310, to cause the processor 1310 to execute the methods described in the method embodiments. The memory 1320 may be separate from the processor 1310 or may be integrated into the processor 1310.

The apparatus 1300 may further include a transceiver 1330. The processor 1310 may communicate with another device or chip by using the transceiver 1330. For example, the processor 1310 may transmit data to and receive data from another device or chip through the transceiver 1330.

An embodiment of the present application further provides a computer-readable storage medium for storing a program. The computer-readable storage medium may be applied to the terminal device or the network device provided in the embodiments of the present application, and the program causes a computer to execute the methods to be executed by the terminal device or the network device in various embodiments of the present application.

The computer-readable storage medium may be any available medium accessible by a computer or a data storage device such as a server or a data center that integrates one or more available media. The usable medium may be a magnetic medium (for example, a floppy disk, a hard disk, or a magnetic tape), an optical medium (for example, a digital video disc (digital video disc, DVD)), a semiconductor medium (for example, a solid-state drive (solid state disk, SSD)), or the like.

An embodiment of the present application further provides a computer program product. The computer program product includes a program. The computer program product may be applied to the terminal device or the network device provided in the embodiments of the present application, and the program causes a computer to execute the methods executed by the terminal device or the network device in various embodiments of the present application.

All or a part of the foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (digital subscriber line, DSL)) manner or a wireless (for example, infrared, wireless, and microwave) manner.

An embodiment of the present application further provides a computer program. The computer program may be applied to the terminal device or the network device provided in the embodiments of the present application, and the computer program causes a computer to execute the methods executed by the terminal device or the network device in various embodiments of the present application.

The terms “system” and “network” in the present application may be used interchangeably. In addition, the terms used in the present application are merely used to explain the specific embodiments of the present application, and are not intended to limit the present application. In the specification, claims, and accompanying drawings of the present application, the terms “first”, “second”, “third”, “fourth”, and so on are intended to distinguish between different objects but do not describe a particular sequence. In addition, the terms “include” and “have” and any variations thereof are intended to cover a non-exclusive inclusion.

In embodiments of the present application, “indication” mentioned herein may be a direct indication, or may be an indirect indication, or may mean that there is an association relationship. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association relationship between A and B.

In embodiments of the present application, the term “corresponding” may mean that there is a direct or indirect correspondence between two elements, or that there is an association between two elements, or that there is a relationship of “indicating” and “being indicated”, “configuring” and “being configured”, or the like.

In embodiments of the present application, the terms “predefined” or “pre-configured” may be implemented by pre-storing corresponding codes, tables, or other forms that may be used to indicate related information in devices (for example, including a terminal device and a network device), and a specific implementation thereof is not limited in the present application. For example, being predefined may refer to being defined in a protocol.

In embodiments of the present application, the “protocol” may indicate a standard protocol in the communication field, which may include, for example, an LTE protocol, an NR protocol, and a related protocol applied to a future communications system. This is not limited in the present application.

In embodiments of the present application, determining B based on A does not mean determining B based on only A, but instead B may be determined based on A and/or other information.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of the present application, sequence numbers of the foregoing processes do not mean execution orders. The execution orders of the processes should be determined based on functions and internal logic of the processes, and should not be construed as any limitation on the implementation processes of embodiments of the present application.

In several embodiments provided in the present application, it should be understood that, the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or another form.

The units described as separate parts may be or may not be physically separate, and parts displayed as units may be or may not be physical units, and may be at one location, or may be distributed on a plurality of network elements. A part or all of the units may be selected based on actual requirements to achieve the objectives of the solutions of embodiments.

In addition, functional units in embodiments of the present application may be integrated into one processing unit, or each of the units may exist alone physically, or two or more units may be integrated into one unit.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A method for wireless communication, comprising: receiving, by a terminal device, first configuration information, wherein the first configuration information indicates an association identity (ID); and performing, by the terminal device based on the association ID, model training and model inference on a first model, wherein the first model corresponds to a first beam set and a second beam set, and the association ID comprises one or more of following: a set ID used for selecting at least one of the first beam set or the second beam set; or a beam ID group, comprising an ID of each beam in at least one of the first beam set or the second beam set.

2. The method according to claim 1, wherein the association ID is one of a plurality of association IDs, and the plurality of association IDs are in a one-to-one correspondence with a plurality of network devices.

3. The method according to claim 1, wherein the association ID is a set ID, and the association ID corresponds to one or more network devices in a first tracking area update (TAU) area.

4. The method according to claim 1, wherein the association ID is one of a plurality of association IDs, and the plurality of association IDs correspond to one network device.

5. The method according to claim 1, wherein the association ID is related to a cell in which the terminal device is located, and the association ID is adjusted based on a network requirement and network load of the cell.

6. The method according to claim 1, wherein the association ID is the set ID, and the first configuration information is carried in resource configuration information of at least one of the first beam set or the second beam set.

7. The method according to claim 6, wherein the first configuration information is carried in one type of following information: resource configuration information shared by the first beam set and the second beam set; a configuration report shared by the first beam set and the second beam set; or first resource configuration information corresponding to the first beam set and second resource configuration information corresponding to the second beam set.

8. The method according to claim 1, wherein the method further comprises: transmitting, by the terminal device, a first report based on an inference result of the first model, wherein the association ID is the set ID, and the first configuration information is carried in a trigger list related to the first report.

9. The method according to claim 8, wherein the first configuration information is carried in one type of following information of the trigger list: a general list of related report configuration information; or a first related report configuration information list corresponding to the first beam set and a second related report configuration information list corresponding to the second beam set.

10. The method according to claim 1, wherein the association ID is the set ID, and the association ID is carried in radio resource control (RRC) signalling.

11. The method according to claim 1, wherein the association ID is the beam ID group, the beam ID group is represented by using a beam association ID matrix, and the beam association ID matrix indicates a mapping relationship between the first beam set and the second beam set.

12. The method according to claim 11, wherein the beam association ID matrix is determined based on a beam resource index of the first beam set and a beam resource index of the second beam set.

13. The method according to claim 1, wherein whether to adjust the association ID is determined based on one or more of following information: a time interval between the model training and the model inference; channel variation corresponding to the model training and the model inference; or whether a beam feature of the first beam set and a beam feature of the second beam set are stable.

14. The method according to claim 1, wherein the first beam set and the second beam set are used to transmit a channel state information reference signal (CSI-RS), a resource of the first beam set is indicated by using a first parameter, a resource of the second beam set is indicated by using a second parameter, and the first parameter and the second parameter comprise one of following: the first parameter and the second parameter are different CSI-Resource ConfigIDs; the first parameter and the second parameter are a same CSI-Resource ConfigID; the first parameter is a CSI-Resource ConfigID, and the second parameter is a configuration parameter of a plurality of resource sets; or the first parameter is a dedicated information element of the first beam set, and the second parameter is CSI-RS-Resource Set List.

15. The method according to claim 1, wherein whether to update the first model is determined based on a first-type trigger event, and the first-type trigger event comprises one or more of following: a hash value bound to the association ID changes; RRC signalling indicates that or the terminal device determines that a network configuration corresponding to the association ID changes; a change range of a network configuration exceeds a set threshold; or at least one of a location or an association ID obtained after the terminal device re-accesses a cell changes.

16. The method according to claim 15, wherein the first model is a local model in federated learning, the terminal device is one of a plurality of terminal devices participating in the federated learning, and the method further comprises: transmitting, by the terminal device, update information of the first model to another terminal device in the plurality of terminal devices.

17. The method according to claim 1, wherein the first model is an artificial intelligence or a machine learning model.

18. A method for wireless communication, comprising: transmitting, by a network device, first configuration information, wherein the first configuration information indicates an association identity (ID), wherein the association ID is used by a terminal device to perform model training and model inference on a first model, the first model corresponds to a first beam set and a second beam set, and the association ID comprises one or more of following: a set ID used for selecting at least one of the first beam set or the second beam set; or a beam ID group, comprising an ID of each beam in at least one of the first beam set or the second beam set.

19. An apparatus, comprising: at least one processor; and one or more non-transitory computer-readable storage media coupled to the at least one processor and storing programming instructions for execution by the at least one processor, wherein the programming instructions, when executed, cause the apparatus to perform operations comprising: receiving first configuration information, wherein the first configuration information indicates an association identity (ID); and performing, based on the association ID, model training and model inference on a first model, wherein the first model corresponds to a first beam set and a second beam set, and the association ID comprises one or more of following: a set ID used for selecting at least one of the first beam set or the second beam set; or a beam ID group, comprising an ID of each beam in at least one of the first beam set or the second beam set.

20. The apparatus according to claim 19, wherein the association ID is one of a plurality of association IDs, and the plurality of association IDs are in a one-to-one correspondence with a plurality of network devices.
